(19) United States
(12) Patent Application Publication
(10) Pub. No.: US 2009/0328038 A1
(43) Pub. Date: Dec. 31, 2009

(54) Computer System and Device Controlling Method for Computer System

(75) Inventors: Tatsuya Yamada, Kawasaki-shi (JP); Hiroshi Nakajima, Nishitokyo-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/485,673

(22) Filed: Jun. 16, 2009

(30) Foreign Application Priority Data
Jun. 27, 2008 (JP) 2008-169087

(51) Int. Cl. G06F 9/455; G06F 15/16

(52) U.S. Cl. 718/1; 709/226

(57) ABSTRACT

According to one embodiment, a computer system configured such that a virtual machine including a guest operating system running on a source computer connected to a network migrates to a destination computer connected to the network, where the virtual machine then running on the destination computer wherein, the source computer comprises first hardware, a first backend driver running in a first hypervisor running on the first hardware, and configured to directly control the device in association with communication performed via a first interface, the virtual machine comprises a frontend driver configured to run in the guest operating system, and to control the device, the destination computer comprises second hardware, the second hypervisor running on the second hardware, and to manage the virtual machine, and a second backend driver configured to run in the second hypervisor and including a second interface which is the same as the first interface.

### CROSS-REFERENCE TO RELATED APPLICATIONS

This application is based upon and claims the benefit of priority from Japanese Patent Application No. 2008-169087, filed Jun. 27, 2008, the entire contents of which are incorporated herein by reference.

### BACKGROUND

1. Field

One embodiment of the present invention relates to a computer system in which a virtual machine is migratable, and a device controlling method for the computer system.

2. Description of the Related Art

In recent years, much effort has been made to study virtual machine techniques. Migration is a virtual machine technique. The migration involves migrating a virtual machine running in a source host to a destination host, where the migrated virtual machine is then ran. The configuration of a device in the destination host is different from that in the source host. The source host may desire to utilize the device in the destination host.

Jpn. Pat. Appln. KOKAI Publication No. 2004-258840 discloses a technique of allowing a device driver of a guest OS in the virtual machine to communicate with a device driver present on a hypervisor in a particular server to utilize the device via a network.

However, the above-described technique needs to modify the device driver of the guest OS so that the device driver can communicate with the device driver on the hypervisor. However, the device driver used by the guest OS is provided by a vender and is difficult to modify.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a computer system according to an embodiment of the present invention;

FIG. 2 is an exemplary block diagram showing a configuration of a computer system according to an embodiment of the present invention; and

FIG. 3 is an exemplary block diagram showing a configuration of a computer system according to an embodiment of the present invention.

### DETAILED DESCRIPTION

Various embodiments according to the invention will be described hereinafter with reference to the accompanying drawings. In general, according to one embodiment of the invention, a computer system configured such that a virtual machine including a guest operating system running on a source computer connected to a network migrates to a destination computer connected to the network, where the virtual machine then running on the destination computer wherein, the source computer comprises first hardware including a first processor, a first network interface, and a device, a first hypervisor configured to run on the first hardware, and to manage the virtual machine, and a first backend driver running in the first hypervisor and configured to directly control the device in association with communication performed via a first interface, the virtual machine comprises a frontend driver configured to run in the guest operating system, and to control the device, the destination computer comprises second hardware including a second processor, and a second network interface, a second hypervisor configured to run on the second hardware, and to manage the virtual machine, and a second backend driver configured to run in the second hypervisor and including a second interface which is the same as the first interface, wherein the frontend driver controls the device by performing communication, via the first interface, with the first backend driver, the communication relates to control of the device, when the virtual machine runs on the source computer, and the frontend driver controls the device by performing communication which being related to control of the device, via the second interface, with the second backend driver, and performing communication which being related to control of the device, the second backend driver and the first backend driver, when the virtual machine runs on the destination computer.

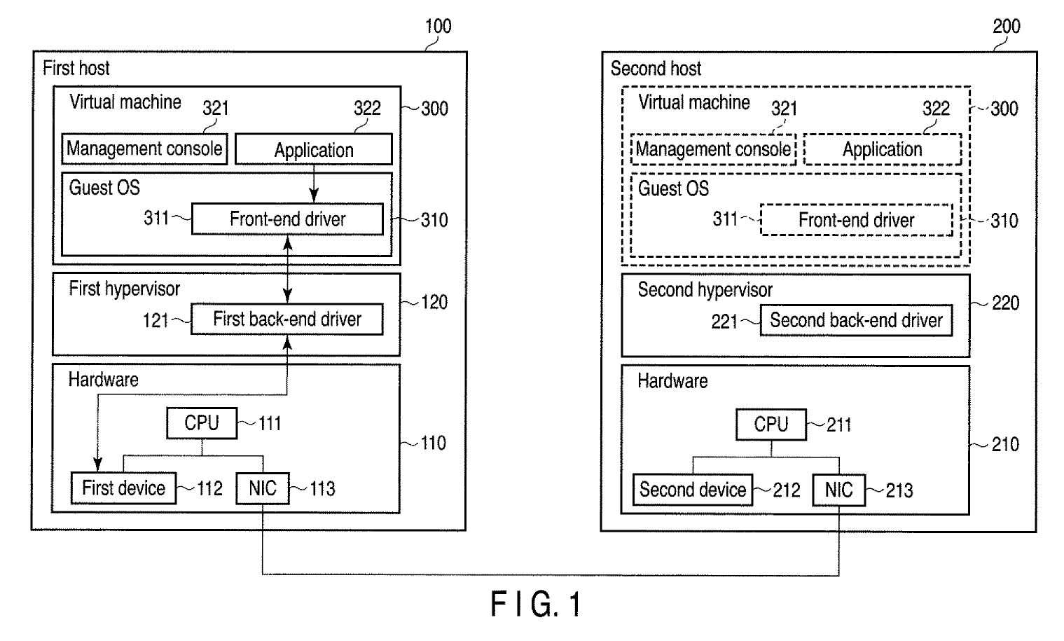

FIG. 1 is a diagram showing a configuration of a computer system according to a first embodiment of the present invention.

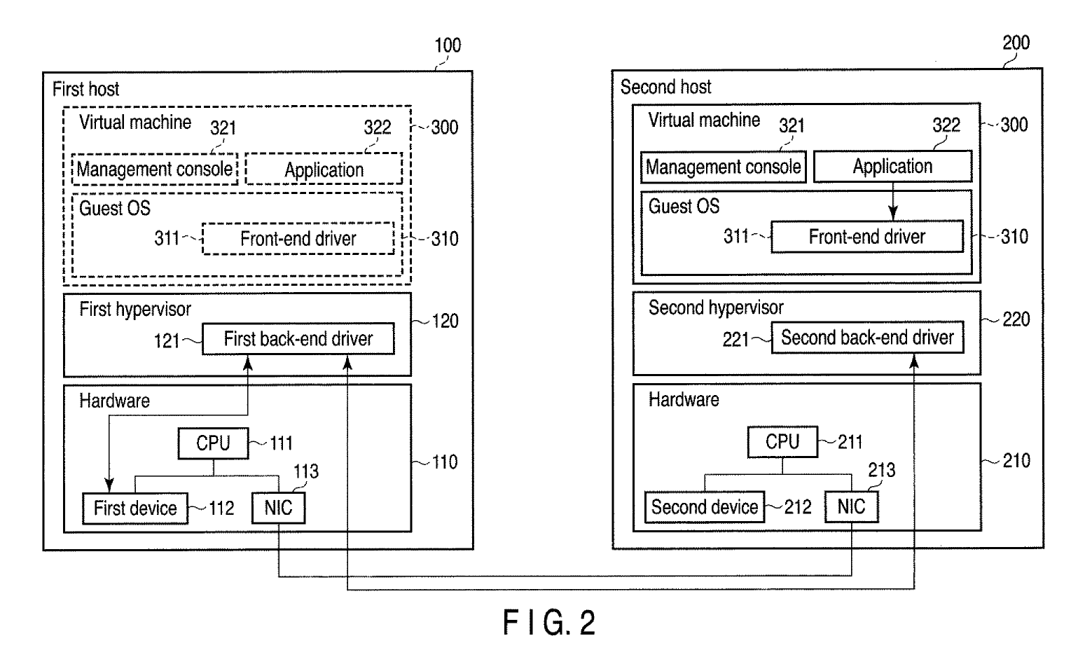

As shown in FIG. 2, a first host 100 includes first hardware 110 provided with CPU 111, a first device 112, and a first network interface card. (NIC) 113. A first hypervisor 120 runs on the first hardware 110. A virtual machine 300 runs under the management of the first hypervisor 120. A guest operating system (hereinafter referred to as a guest OS) 310 runs under the management of the virtual machine 300. In the virtual machine 300, a management console 321 and applications 322 such as an Internet browser, a word processor, and a spread sheet run under the management of the guest OS 310.

A first backend driver 121 that is software controlling the first device 112 runs in the first hypervisor 120. The first backend driver 121 provides an abstracted interface for a frontend driver 311 of the guest OS 310. The first backend driver 121 can directly control devices.

The frontend driver 311, which controls the device, runs in the guest OS 310. The frontend driver 311 communicates with the first backend driver 121 to indirectly control the device via the first backend driver 121.

A communication interface between the frontend driver 311 and the first backend driver 121 is generally made up of a buffer (hereinafter referred to as a communication buffer) for data communication with an event notification buffer (hereinafter referred to as an event channel). The communication buffer, in spite of its name, may or may not actually communicate with an event notification interface because the frontend driver 311 and a destination backend driver communicate with each other on a local memory.

A second host 200 includes a second hardware 210 provided with CPU 211, a second device 212, and a second network interface card (NIC) 213. A second hypervisor 220 runs on the second hardware 210. As shown in FIG. 2, the virtual machine 300 can be migrated to the second host 200, where the virtual machine 300 can then be ran.

A second backend driver 221 that is software controlling the first device 112 runs in the second hypervisor 220. The second backend driver 221 provides the frontend driver 311 of the guest OS 310 with the same abstracted interface as that provided by the first backend driver 121.

If the virtual machine 300 migrates to the second host 200, the guest OS 310 is utilizing no device in the destined second host 200 but may desire to continuously utilize the first device 112 in the originating first host.

After the virtual machine 300 migrates to the second host 200, the management console 321 notifies the second backend driver 221 of a MAC address as a unique identifier inherent in a first network interface card. The second backend driver 221 detects a corresponding first host based on a MAC address. Then, the second backend driver 221 can communicate with the first backend driver 121 in the first host. Data exchanges for data outputs and inputs to and from the device are then performed through communication between the frontend driver 311 and the second backend driver 221 and communication between the second backend driver 221 and the first backend driver 121. The data exchanged between the frontend driver 311 and the second backend driver 221 is almost the same as that exchanged between the second backend driver 221 and the first backend driver 121. Thus, the format of the data transferred in the respective communications can be unified.

The backend drivers 121 and 221 need to add a tag indicating to which frontend driver 311 data being transmitted or received belongs, to the data. A common data communication technique may be used for the addition of the tags.

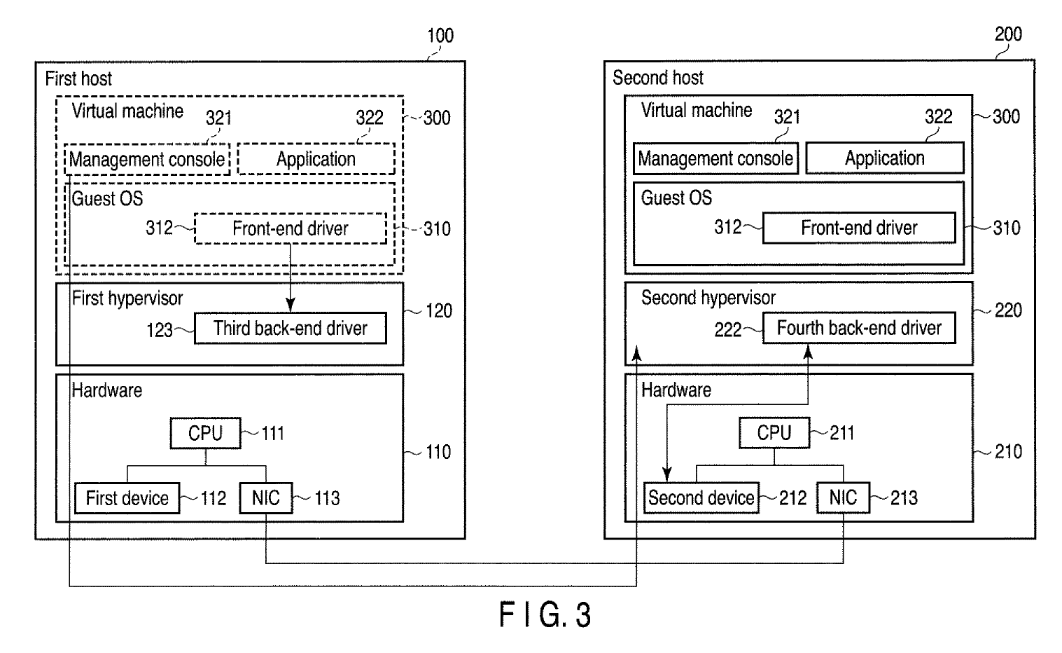

As shown in FIG. 3, when the virtual machine 300 migrates from the first host 100 to the second host 200, the management console 321, running in the first host 100, requests the second hypervisor 220 to reserve the use of the second device 212 in the destined second host 200. Then, a fourth backend driver 222 mounted in the destined second hypervisor 220 is connected to a third backend driver 122, running in the originating first hypervisor 120, and further to the frontend driver 311, mounted in the source guest OS 310. At this time, the source guest OS 310 can utilize the destination second device 212 before the migration. Then, after the migration, the virtual machine 300 can immediately use the second device 212 without a special operation.

The fourth backend driver 222 and the third backend driver 122 include the same interface. The fourth backend driver 222 directly controls the second device 212 in association with communication relating to control of the second device 212 performed between the fourth backend driver 222 and the third backend driver 122 or the second frontend driver.

As described above, if the virtual machine 300 migrates from the first host to the second host 200, then by continuing to use the same frontend driver 311 and connecting to the destination backend driver, the guest OS 310 can continuously utilize the device in the destination as is the case in which the configuration of the device remains unchanged.

When the frontend driver 311 uses a device in a remote host, the backend driver in the host in which the guest OS is operating communicates with a backend driver running in the remote host, in place of the frontend driver 311. Thus, the presence of the backend driver can be hidden from the implementation in the guest OS. Consequently, the level of abstraction of the equipment as viewed from the gust OS is increased to allow the equipment to be easily configured.

Furthermore, the hardware is actually operated by the backend driver, and the frontend driver need not be changed. Thus, even when the frontend driver, which cannot be easily changed, is used, the system can be easily made compatible with the latest hardware.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer system configured such that a virtual machine including a guest operating system running on a source computer connected to a network migrates to a destination computer connected to the network, where the virtual machine then running on the destination computer wherein,
the source computer comprises:
first hardware including a first processor, a first network interface, and a device;
a first hypervisor configured to run on the first hardware, and to manage the virtual machine; and
a first backend driver running in the first hypervisor, and configured to directly control the device in association with communication performed via a first interface,
the virtual machine comprises:
a frontend driver configured to run in the guest operating system, and to control the device,
the destination computer comprises:
second hardware including a second processor, a second network interface;
a second hypervisor configured to run on the second hardware, and to manage the virtual machine; and
a second backend driver configured to run in the second hypervisor and including a second interface which is the same as the first interface,
wherein the frontend driver controls the device by performing communication, via the first interface, with the first backend driver, the communication relates to control of the device, when the virtual machine runs on the source computer, and
the frontend driver controls the device by performing communication which being related to control of the device, via the second interface, with the second backend driver, and performing communication which being related to control of the device, the second backend driver and the first backend driver, when the virtual machine runs on the destination computer.

2. The computer system of claim 1, wherein the second backend driver starts communicating with the first backend driver by indicating a management application running on the guest operating system in the virtual machine indicating the source computer to the second backend driver, when the virtual machine runs on the destination computer.

3. The computer system of claim 2, wherein the management application specifies a unique identifier of the first network interface in order to indicate the source computer.

4. The computer system of claim 1, wherein the destination computer further comprises a second device,
the second device is controlled by a second frontend driver run in the guest operating system of the virtual machine,
the second device is controlled by the a third backend driver run in the second hypervisor, the third backend driver directly controls the second device in association with communication performed via a third interface,
the first hypervisor comprising a fourth backend driver including a fourth interface which is the same as the third interface,
the virtual machine further comprises request issuing module configured to, with the virtual machine running in the source computer, issue a request for utilization of the second device to the second hypervisor,
the second hypervisor allows communication between the third backend driver and the fourth backend driver in response to the request, and
the first hypervisor allows communication between the fourth backend driver and the second frontend driver.

5. A device controlling method for a computer system configured such that a virtual machine including a guest operating system running on a source computer connected to a network, migrating to a destination computer connected to the network, where the virtual machine then runs on the destination computer,
wherein the source computer comprises;
first hardware including a first processor, a first network interface, and a device;
a first hypervisor running on the first hardware, and configured to manage the virtual machine; and
a first backend driver running in the first hypervisor, and configured to directly control the device in association with communication performed via the first interface, and
the virtual machine comprises a frontend driver running in the guest operating system, and configured to control the device,
wherein the destination computer comprises:
second hardware including a second processor, and
a second network interface;
a second hypervisor configured to run on the second hardware, and to manage the virtual machine; and
a second backend driver configured to run in the second hypervisor and including a second interface which is the same as the first interface, and
wherein the method comprises:
causing the frontend driver to control the device by performing a communication which relates to control of the device the frontend driver, via the first interface, with first backend driver for controlling the device;
migrating the virtual machine from the source computer to the destination computer, and
causing the frontend driver to control the device by performing communication which relates to control of the device, via the second interface, with the second backend driver, and performing communication which relates to control of the device, the second backend driver and the first backend driver, when the virtual machine runs on the destination commuter.

6. The device controlling method of claim 5, wherein a management application running on the guest operating system in the virtual machine indicates the source computer to the second backend driver to allow the second backend driver to start communicating with the first backend driver, when the virtual machine runs on the destination commuter.

7. The device controlling method of claim 6, wherein the management application specifies a unique identifier of the first network interface in order to indicate the source computer.

8. The device controlling method of claim 6, wherein
a second frontend driver for controlling the second device runs in the quest operating system of the virtual machine,
a third backend driver which directly controls the second device runs in the second hypervisor in association with communication performed via a third interface,
the second backend driver includes a fourth interface which is the same as the third interface, and runs in the first hypervisor,
the virtual machine issues a request for using the second device to the second hypervisor, when virtual machine runs on the source computer,
the second hypervisor allows communication between the third backend driver and the fourth backend driver in response to the request, and
the first hypervisor allows communication between the fourth backend driver and the second frontend driver.
